(19) United States
(12) Patent Application Publication
(10) Pub. No.: US 2011/0270953 A1
(43) Pub. Date: Nov. 3, 2011

(54) METHOD AND SYSTEM FOR SECURE DISTRIBUTED COMPUTING

(75) Inventors: Daniel Levine, New York, NY (US); Andrew Slezak, Hoboken, NJ (US)

(73) Assignee: CYTEXONE Corporation, New York, NY (US)

(21) Appl. No.: 13/143,291

(22) PCT Filed: Oct. 27, 2009
(86) PCT No.: PCT/US09/62186

§ 371 Date: Jul. 5, 2011

Related U.S. Application Data
(60) Provisional application No. 61/142,717, filed on Jan. 6, 2009.

(51) Int. Cl. G06F 15/16

(52) U.S. Cl. 709/218

(57) ABSTRACT

There is provided a method for accessing a device in a secure network. The method is performed by a first apparatus, and includes communicating with a second apparatus via a network connection, communicating with a third apparatus via a secured virtual network connection, and routing data between the second apparatus and the third apparatus, via the network connection and the secured virtual network connection.

### BACKGROUND OF THE INVENTION

1. Field of the Invention

The present invention relates to distributed computing, and more particularly, a distributed computing platform that allows a customer to access a traditionally ‘closed’ network, for network programming, monitoring, maintenance, and future upgrades. An embodiment of a system described herein includes a secure virtual private network connection to a core infrastructure to allow for future upgradability and scalability of the distributed computing platform, including the installation of new programs and features.

2. Description of the Related Art

Security in a network is often inversely related to how freely one can remotely access the network. In many situations, this inverse relationship is desired, however, when there is a need to monitor, configure, or otherwise work within the network at a site, it is often impossible without having someone with intimate technical knowledge of the network physically present at the site to enable access. Even with a simple private network configuration, due to a firewall or other security measure installed on a system being accessed, there is only limited access, and such access is furthermore limited by not being able to, or not wanting to, install additional programs or features in the system. The present invention resolves these and other problems associated with network security.

### SUMMARY OF THE INVENTION

There is provided a method for accessing a device in a secure network. The method is performed by a first apparatus, and includes communicating with a second apparatus via a network connection, communicating with a third apparatus via a secured virtual network connection, and routing data between the second apparatus and the third apparatus, via the network connection and the secured virtual network connection.

### BRIEF DESCRIPTION OF THE DRAWINGS

FIG. 1 is a block diagram of a networked computer system that includes a host computer and a domain infrastructure.

FIG. 2 is block diagram of relevant features of the domain infrastructure of FIG. 1.

FIG. 3 is block diagram of relevant features of the host computer of FIG. 1.

A component or a feature that is common to more than one drawing is indicated with the same reference number in each of the drawings.

### DESCRIPTION OF THE INVENTION

A physical network connection is a channel of communication. The phrase “physical network connection” is a term of art, as the physical network connection in not necessarily “physical”, but may include wire conductors or fiber optic lines, and may also include a wireless link.

A virtual network is a computer network that consists, at least in part, of virtual network links. A virtual network connection is a link that is not a physical (wired or wireless) connection between two computing devices but is instead implemented using methods of network virtualization.

A secured virtual network is a virtual network that utilizes encryption to protect data that crosses between computing devices.

A virtual machine (VM) is a software program that emulates a hardware system.

A hypervisor, also called a virtual machine manager, is a program that implements multiple operating systems in a single hardware host. The host has a host operating system, and additional operating systems known as guest operating systems are implemented in virtual machines. Each operating system appears to have the host's processor, memory, and other resources all to itself. However, the hypervisor is actually controlling the host processor and resources, allocating the resources to each operating system in turn, and ensuring that the guest operating systems do not disrupt one another.

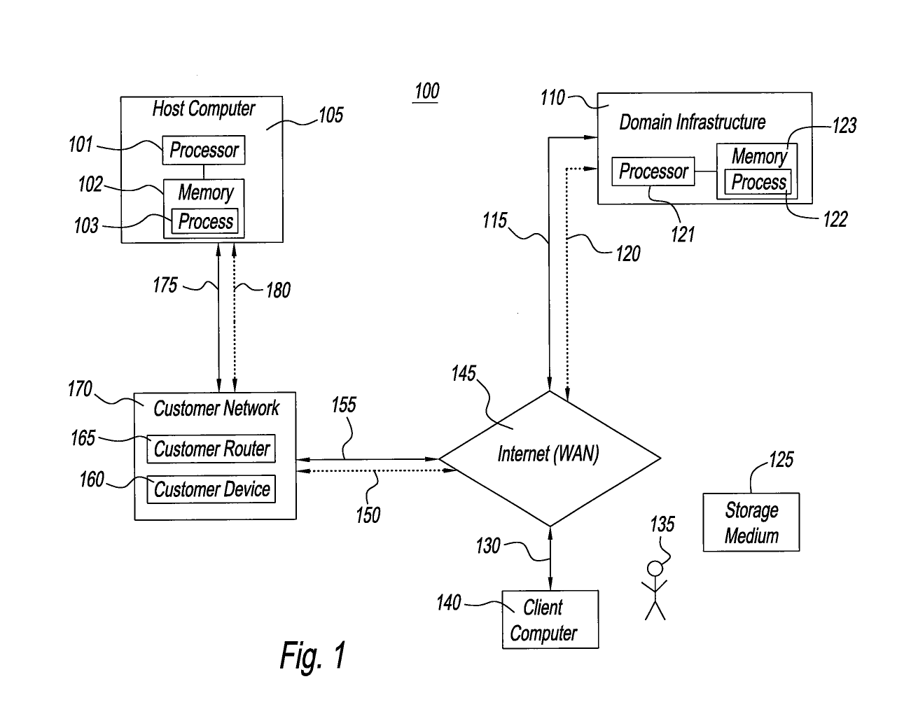

FIG. 1 is a block diagram of a networked computer system, i.e., system 100. System 100 includes several apparatuses, namely a host computer 105, a domain infrastructure 110, and a client computer 140. System 100 also includes, a customer network 170, a wide area network (WAN), e.g., Internet 145, physical network connections 175, 155 and 115, secured virtual network connections 180, 150 and 120, and a network connection 130.

Host computer 105 includes a processor 101 and a memory 102. Memory 102 contains instructions, tangibly embodied in a process 103, that are readable by processor 101, and that control operations of processor 101. Memory 102 may be implemented in a random access memory (RAM), a hard drive, a read only memory (ROM), or a combination thereof. Processor 101 is configured of logic circuitry that responds to and executes the instructions in process 103, and thus performs actions, described below, on behalf of host computer 105. Process 103 may be embodied either as a stand-alone component, i.e., a single process, or as an integrated configuration of a plurality of sub-ordinate components, i.e., sub-processes. Host computer 105 may be implemented, for example, on a general-purpose computer, and if desired, may be implemented as “a headless computer”, which does not require a keyboard, mouse or display to function correctly. Host computer 105 is coupled to customer network 170 via physical network connection 175 and secured virtual network connection 180. Communications conducted via secured virtual network connection 180 are carried over physical network connection 175.

Domain infrastructure 110 includes a processor 121 and a memory 123. Memory 123 contains instructions, tangibly embodied in a process 122, that are readable by processor 121, and that control operations of processor 121. Memory 123 may be implemented in a random access memory (RAM), a hard drive, a read only memory (ROM), or a combination thereof. Processor 121 is configured of logic circuitry that responds to and executes the instructions in process 122, and thus performs actions, described below, on behalf of domain infrastructure 110. Process 122 may be embodied either as a stand-alone component, i.e., a single process, or as an integrated configuration of a plurality of sub-ordinate components, i.e., sub-processes. Domain infrastructure 110 may be implemented, for example, on a general-purpose computer. Domain infrastructure 110 is coupled to Internet 145 via physical network connection 115 and secured virtual network connection 120. Communications conducted via secured virtual network connection 120 are carried over physical network connection 115.

Client computer 140 can be implemented on a general-purpose computer having a user interface that includes (a) an input device, such as a keyboard or speech recognition subsystem, for enabling a user 135 to communicate information and command selections to client computer 140, and (b) an output device such as a display or a speaker through which client computer 140 communicates information to user 135. Client computer 140 is coupled to Internet 145 via network connection 130. Network connection 130 is a physical network connection.

Customer network 170 includes apparatuses, namely a customer router 165 and a customer device 160. Customer router 165 is a router that routes data communications through customer network 170. Customer device 160 can be any network-compatible device, for example, a computer, a database or a printer. Although customer network 170 is shown as having only one customer device 160, customer network 170 may include a plurality of customer devices. Customer network 170 is coupled to Internet 145 via physical network connection 155 and secured virtual network connection 150. Communications conducted via secured virtual network connection 150 are carried over physical network connection 155.

If customer network 170 is a private network, or is protected by a security measure, for example a firewall (not shown), user 135, when using client computer 140, could not ordinarily initiate access to customer network 170, or for that matter, any of customer router 165, customer device 160 or host computer 105. However, as explained below, system 100, and in particular host computer 105 and domain infrastructure 110, pursuant to processes 103 and 122, respectively, allow user 135 to access devices that are located behind the firewall.

Assume that user 135 wishes to access host computer 105. User 135 communicates this wish to domain infrastructure 110, for example, by way of a request to domain infrastructure 110. The request is transmitted from client computer 140, through network connection 130, Internet 145 and physical network connection 115, to domain infrastructure 110. Domain infrastructure 110 communicates with client computer 140 via a network connection, that is by way of physical network connection 115, Internet 145 and network connection 130. Domain infrastructure 110 communicates with host computer 105 via a secured virtual network connection 120, 150 and 180. Domain infrastructure 110 routes data between client computer 140 and host computer 105 via the network connection and the secured virtual network connection. The data can be a command, from client computer 140, that controls an operation of host computer 105.

Assume further that user 135 wishes to access customer device 160. Communication is established between client computer 140 and host computer 105, as described above. Host computer 105 communicates with customer device 160 via a network connection, e.g., physical network connection 175 and customer network 170. Host computer 105 communicates with domain infrastructure 110 via the secured virtual network connection 180, 150 and 120. Host computer 105 routes data between customer device 160 and domain infrastructure 110 via the network connection and the secured virtual network connection. The data between client computer 140 and host computer 105, which is communicated via domain infrastructure 110, is further communicated between host computer 105 and customer device 160. Thus, the data is being communicated between client computer 140 and customer device 160. The data can be a command, from client computer 140, that controls an operation of customer device 160.

Although host computer 105 and domain infrastructure 110 are described herein as having processes 103 and 122 installed into memories 102 and 123, respectively, either or both of processes 103 and 122 can be tangibly embodied on an external computer-readable storage medium 125 for subsequent loading into memory 102 and/or memory 123. Storage medium 125 can be any conventional storage medium, including, but not limited to, a floppy disk, a compact disk, a magnetic tape, a read only memory, an optical storage medium, universal serial bus (USB) flash drive, a digital versatile disc, or a zip drive. The instructions could also be embodied in a random access memory, or other type of electronic storage, located on a remote storage system and coupled to memory 102 and/or memory 123. Moreover, although processes 103 and 122, are described herein as being installed in memories 102 and 123, respectively, and therefore being implemented in software, they could be implemented in any of hardware (e.g., electronic circuitry), firmware, software, or a combination thereof.

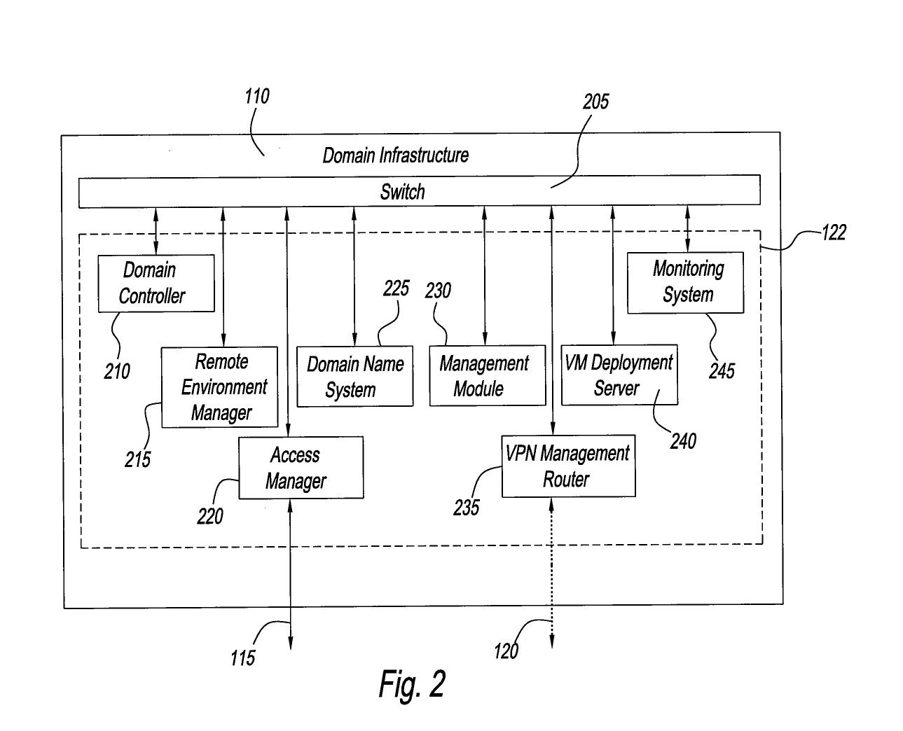

FIG. 2 is block diagram of relevant features of domain infrastructure 110. Domain infrastructure 110 includes process 122, as mentioned above, and further includes a switch 205. Process 122 includes several components, namely, a domain controller 210, a remote environment manager 215, an access manager 220, a domain name system 225, a management module 230, a virtual private network (VPN) management router 235, a VM deployment server 240 and a monitoring system 245, each of which is connected to switch 205 via a virtual network connection. Switch 205 is a virtual local area network (VLAN) switch for routing data between the components of process 122.

Domain controller 210 provides authentication and permissions for administration of domain infrastructure 110.

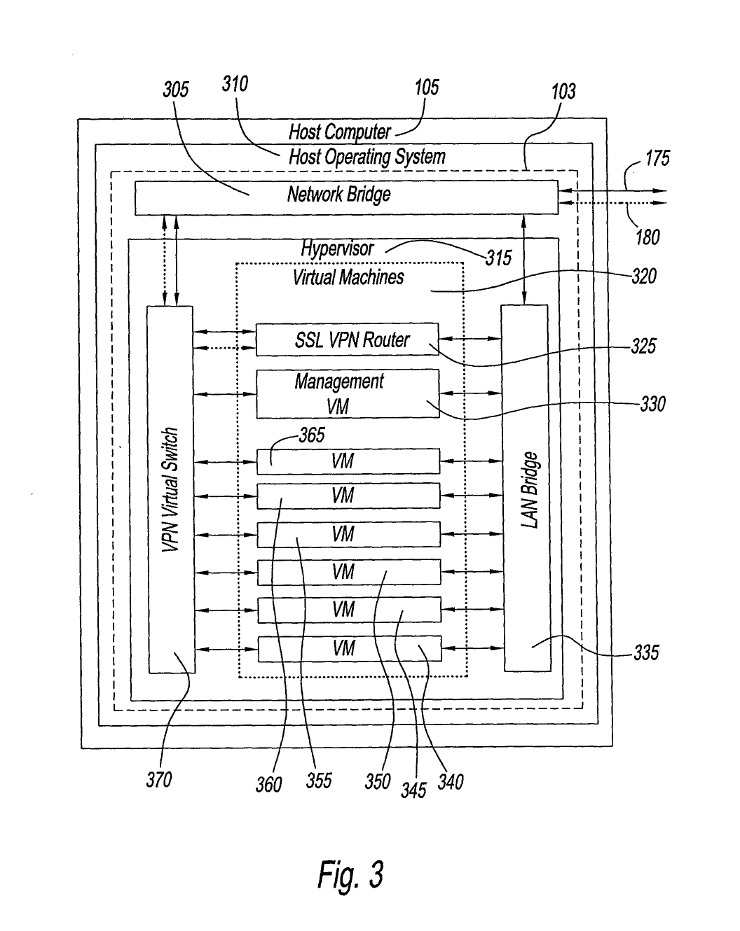

Remote environment manager 215 provides remote software deployment and system configuration of virtual machines 320 (see FIG. 3) in host computer 105.

Access manager 220 is a server that provides encrypted, multi-point authentication for remote users. It provides a gateway for a remote user to access host computer 105 and its individual parts.

Domain name system 225 provides domain name system resolution for host computer 105, customer network 170, and individual parts contained within both host computer 105 and customer network 170.

Management module 230 is a server that provides a gateway from domain infrastructure 110 to manage host computer 105 and its individual parts.

VPN management router 235 is a router that an administrator uses to manage, program or monitor operations of VPN connections throughout host computer 105 through to domain infrastructure 110. VPN management router 235 routes all relevant traffic from domain infrastructure 110 through secured virtual network connections 120, 150 and 180, to reach host computer 105.

VM deployment server 240 allows for remote deployment of virtual machines 320 (see FIG. 3).

Monitoring system 245 is a server that monitors system and network performance, uptime, and faults for host computer 105, customer network 170, and all individual parts contained within.

FIG. 3 is block diagram of relevant features of host computer 105. Host computer 105 includes a host operating system 310, and subordinate thereto, process 103. Process 103 includes a network bridge 305 and a hypervisor 315.

Hypervisor 315 allows multiple virtual machines, e.g., virtual machines 320, to run concurrently on host computer 105. In this regard, hypervisor 315 oversees operations of a VPN virtual switch 370, virtual machines 320 and a local area network (LAN) bridge 335. Virtual machines 320 include a secure sockets layer (SSL) VPN router 325, a management VM 330, and one or more other VMs 365, 360, 355, 350, 345 and 340.

Network bridge 305 is a bridge between host operating system 310 and hypervisor 315. Network bridge 305 is coupled to physical network connection 175 and secured virtual network connection 180. Network bridge 305 is also coupled to VPN virtual switch 370 and LAN bridge 335.

VPN management router 235 and SSL VPN router 325 are configured to create secured virtual network connections 120, 150 and 180, in real time, whenever host computer 105 has access to Internet 145.

Assume again that user 135 requires access to customer device 160. System 100 creates a VPN tunnel (signified in all figures as dotted lines, and specifically detailed as secured virtual network connection 180, secured virtual network connection 150, and secured virtual network connection 120) between SSL VPN router 325 (in host computer 105) and VPN management router 235 (in domain infrastructure 110). This VPN tunnel allows domain controller 210, remote environment manager 215, access manager 220, domain name system 225, management module 230, VM deployment server 240, and monitoring system 245 to all connect to customer network 170.

The following several paragraphs describe a path for data from client computer 140 to customer device 160.

The data travels from client computer 140, through network connection 130 to Internet 145, through physical network connection 115 into domain infrastructure 110. In domain infrastructure 110, the data travels from physical network connection 115, to access manager 220, through switch 205, to VPN management router 235, and out of domain infrastructure 110 to secured virtual network connection 120. The data then travels through secured virtual network connection 120, Internet 145, and secured virtual network connection 150 to customer router 165. From customer router 165, the data travels through secured virtual network connection 180 to host computer 105. In host computer 105, the data travels from secured virtual network connection 180 to network bridge 305, to VPN virtual switch 370, and to SSL VPN router 325. The path that the data takes from SSL VPN router 325 depends on whether the data requires some processing or transformation before being presented to customer device 160. A determination of which pathway to take is configured in access manager 220.

If the data does not require any processing or transformation before being presented to customer device 160, then SSL VPN router 325 forwards the data to LAN bridge 335, and the data then travels through network bridge 305 and physical network connection 175, to customer device 160.

If the data requires some processing or transformation before being presented to customer device 160, then the data will be processed or transformed by operations of one or more of virtual machines 320. For example, assume that the processing or transformation is performed by virtual machine 365. Accordingly, SSL VPN router 325 forwards the data through VPN virtual switch 370 to virtual machine 365. Virtual machine 365 performs the process or transformation, and thereafter forwards the data to LAN bridge 335, and the data then travels through network bridge 305 and physical network connection 175, to customer device 160.

Data traveling from customer device 160 to client computer 140 travels along a path similar to that described above for data traveling from client computer 140 to customer device 160, but in the opposite direction. Also, if the data traveling from customer device 160 to client computer 140 requires some processing or transformation, the processing or transformation can be performed by one or more of virtual machines 320.

User 135 uses network connection 130 to access Internet 145. User 135 then connects to access manager 220. User 135 is prompted to authenticate, which is checked via domain controller 210. After user 135 is authenticated, access manager 220 presents to user 135, via client computer 140, a list of available virtual machines 320 that user 135 is allowed to access. For example, assume that user 135 selects management VM 330. Accordingly, access manager 220 makes a terminal connection to display, on client computer 140, a screen of management VM 330. Management VM 330 has two network connections, one connected to VPN virtual switch 370, and the other connected to LAN bridge 335. LAN bridge 335 is directly connected to network bridge 305, which is in turn connected to customer network 170 via physical network connection 175. LAN bridge 335 provides Internet functionality and capability to virtual machines 320. VPN virtual switch 370 provides network connectivity to domain infrastructure 110. Connections through LAN bridge 335 and VPN virtual switch 370 allow user 135 full access to customer device 160. Thus, user 135, through client computer 140, can connect to any of virtual machines 320, and can request monitoring information via monitoring system 245.

If user 135 required specific programs to access customer device 160, remote environment manager 215 can install such programs onto any of virtual machines 320. This installation can involve different operating systems. If user 135 requires another virtual machine, VM deployment server 240 creates them on host computer 105 by sending a communication to host computer 105 that causes hypervisor 315 to establish an additional virtual machine.

System 100 resolves many issues that arise as a consequence of having a closed, protected, and/or private network such as customer network 170. System 100 allows for remote access to traditionally closed networks, for network programming, monitoring, maintenance, and future upgrades. Specifically, by utilizing system 100, user 135 would be connected to customer network 170 in a manner that allows user 135 full access to whatever software is required for configuration or monitoring customer network 170. Additionally, system 100 is scalable so that it can include any desired number of customer networks, host computers and/or domain infrastructures, and is upgradable, thus allowing any other necessary abilities as requested by user 135, while maintaining security of customer network 170 the other customer networks.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

1. A method performed by a first apparatus, comprising:
communicating with a second apparatus via a network connection;
communicating with a third apparatus through the Internet via a secured virtual network connection; and
routing data between said second apparatus and said third apparatus, through said first apparatus, via said network connection and through the Internet via said secured virtual network connection,
wherein said third apparatus is in a secure network,
wherein said second apparatus is not in said secure network, and
wherein said routing enables said second apparatus to initiate access to said third apparatus through said first apparatus.

2. The method of claim 1,
wherein said third apparatus is in communication with a fourth apparatus, and
wherein said data is communicated between said third apparatus and said fourth apparatus.

3. The method of claim 1, wherein said data comprises a command, from said second apparatus, that controls an operation of said third apparatus.

4. The method of claim 1,
wherein said third apparatus is in communication with a fourth apparatus, and
wherein said data comprises a command, from said second apparatus, that controls an operation of said fourth apparatus, via said first apparatus and said third apparatus.

5. The method of claim 1, wherein said data comprises a command, from said third apparatus, that controls an operation of said second apparatus.

6. The method of claim 1,
wherein said third apparatus is in communication with a fourth apparatus, and
wherein said data comprises a command, from said fourth apparatus, that controls an operation of said second apparatus, via said third apparatus and said first apparatus.

7. The method of claim 1, wherein said routing is performed via a virtual machine embodied within said first apparatus.

8. The method of claim 1, further sending a communication to said third apparatus that causes said third apparatus to establish a virtual machine therein.

9. A first apparatus comprising:
a processor; and
a memory that contains instructions that are readable by said processor, and cause said processor to perform actions of:
communicating with a second apparatus via a network connection;
communicating with a third apparatus through the Internet via a secured virtual network connection; and
routing data between said second apparatus and said third apparatus, through said first apparatus, via said network connection and through the Internet via said secured virtual network connection,
wherein said third apparatus is in a secure network,
wherein said second apparatus is not in said secure network, and
wherein said routing enables said second apparatus to initiate access to said third apparatus through said first apparatus.

10. The first apparatus of claim 9,
wherein said third apparatus is in communication with a fourth apparatus, and
wherein said data is communicated between said third apparatus and said fourth apparatus.

11. The first apparatus of claim 9, wherein said data comprises a command, from said second apparatus, that controls an operation of said third apparatus.

12. The first apparatus of claim 9,
wherein said third apparatus is in communication with a fourth apparatus, and
wherein said data comprises a command, from said second apparatus, that controls an operation of said fourth apparatus, via said first apparatus and said third apparatus.

13. The first apparatus of claim 9, wherein said data comprises a command, from said third apparatus, that controls an operation of said second apparatus.

14. The first apparatus of claim 9,
wherein said third apparatus is in communication with a fourth apparatus, and
wherein said data comprises a command, from said fourth apparatus, that controls an operation of said second apparatus, via said third apparatus and said first apparatus.

15. The first apparatus of claim 9, wherein said routing is performed via a virtual machine embodied within said first apparatus.

16. The first apparatus of claim 9, wherein said actions further include sending a communication to said third apparatus that causes said third apparatus to establish a virtual machine therein.

17. A storage medium comprising instructions that are readable by a processor embodied in a first apparatus, and cause said processor to perform actions of:
communicating with a second apparatus via a network connection;
communicating with a third apparatus through the Internet via a secured virtual network connection; and
routing data between said second apparatus and said third apparatus, through said first apparatus, via said network connection and through the Internet via said secured virtual network connection,
wherein said third apparatus is in a secure network,
wherein said second apparatus is not in said secure network, and
wherein said routing enables said second apparatus to initiate access to said third apparatus through said first apparatus.

18. The storage medium of claim 17,
wherein said third apparatus is in communication with a fourth apparatus, and
wherein said data is communicated between said third apparatus and said fourth apparatus.

19. The storage medium of claim 17, wherein said data comprises a command, from said second apparatus, that controls an operation of said third apparatus.

20. The storage medium of claim 17,
wherein said third apparatus is in communication with a fourth apparatus, and
wherein said data comprises a command, from said second apparatus, that controls an operation of said fourth apparatus, via said first apparatus and said third apparatus.

21. The storage medium of claim 17, wherein said data comprises a command, from said third apparatus, that controls an operation of said second apparatus.

22. The storage medium of claim 17,
wherein said third apparatus is in communication with a fourth apparatus, and
wherein said data comprises a command, from said fourth apparatus, that controls an operation of said second apparatus, via said third apparatus and said first apparatus.

23. The storage medium of claim 17, wherein said routing is performed via a virtual machine embodied within said first apparatus.

24. The storage medium of claim 17, wherein said actions further include sending an instruction to said third apparatus that causes said third apparatus to establish a virtual machine therein.

25. A system comprising:
a router that is (a) coupled to a first apparatus via a network connection; and (b) coupled to a second apparatus through the Internet via a secured virtual network connection,
wherein said router routes data between said first apparatus and said second apparatus, through said router, via said network connection and through the Internet via said secured virtual network connection,
wherein said second apparatus is in a secure network,
wherein said first apparatus is not in said secure network, and
wherein said routing enables said first apparatus to initiate access to said second apparatus through said router.

26. The system of claim 25,
wherein said second apparatus is coupled to a third apparatus, and
wherein said first apparatus accesses said third apparatus via said router and said second apparatus.

27. The system of claim 25, wherein said router is embodied in a virtual machine in a computer.
